(19) United States
(12) Patent Application Publication
(10) Pub. No.: US 2006/0191363 A1
(43) Pub. Date: Aug. 31, 2006

(54) Right side motorcycle transmission

(75) Inventors: James R. Thiessen, Somis, CA (US); David K. Whitaker, Camarillo, CA (US); Christopher A. Jenkins, Thousand Oaks, CA (US)

Correspondence Address: CHRISTIE, PARKER & HALE, LLP, PO BOX 7068, PASADENA, CA, 91109-7068, US

(73) Assignee: JIMS MACHINING CORPORATION

(21) Appl. No.: 11/344,262

(22) Filed: Jan. 30, 2006

Related U.S. Application Data
(60) Provisional application No. 60/648,361, filed on Jan. 28, 2005.

(51) Int. Cl. F16H 3/08

(52) U.S. Cl. 74/325

(57) ABSTRACT

A motorcycle transmission is provided which includes a transmission case, an end cover, and a mainshaft gear shaft. The transmission case includes a main portion and a trapdoor. The end cover extends from the trap door. The mainshaft gear shaft is supported by circular bearings placed in the main portion, trapdoor, and the end cover. A lubricant path extends from inside the transmission case, through the walls of the transmission case and the end cover, to the circular bearing in the end cover.

### CROSS-REFERENCE TO RELATED APPLICATION(S)

This patent application is based upon and claims priority of U.S. Provisional Patent Application No. 60/648,361, filed Jan. 28, 2005, the entire contents of which are incorporated by reference herein.

### FIELD OF THE INVENTION

The present invention relates generally to components used in a motorcycle transmission. Alternatively or in addition, the present invention relates generally to components for use in a motorcycle transmission having a right side drive, and to a motorcycle transmission incorporating the same.

### BACKGROUND OF THE INVENTION

In traditional motorcycle transmissions, both the mainshaft (the drive from the motor to the transmission) as well as the output gear (the drive from the transmission to the wheel of the motorcycle) are located on the left side of the motorcycle, the left side being defined as the side of the motorcycle on which the operator normally places his/her left leg. However, the presence of pulleys and other components associated with the mainshaft and the output gear on the left side of the motorcycle can create a concentration of mass on the left side of the motorcycle that can cause the center of gravity to be undesirably located more toward the left side than the right side of the motorcycle.

A more recent trend involves placing the output gear on the right side of the motorcycle in order to more centrally locate the center of gravity of the motorcycle, increasing the balance of the motorcycle and providing a more stable ride for the motorcycle operator. Because the output gear is rotatably coupled to the mainshaft, the mainshaft exits the right side of the transmission case in a right side drive transmission. Proper bearing support for the mainshaft, an output gear, and a pulley is difficult to achieve because the contact between the gear assembly and the transmission case on the right side is formed by a bearing between the transmission case and the output gear. Further, the mainshaft extends outside of the right side of the transmission case. Thus, there is a need for a bearing support for the mainshaft at its far right end.

All bearing supports benefit greatly from proper lubrication. Lack of proper lubrication in a bearing can lead to excessive heat and pressure on components. To the extent that bearing support is used, there is a need to ensure adequate lubrication of a bearing support.

### SUMMARY OF THE INVENTION

The invention provides a motorcycle transmission. In one exemplary embodiment of the invention, the motorcycle transmission has a transmission case, an end cover, and a mainshaft gear shaft. The transmission case includes a left side wall having a first opening therein and having a first bearing placed in the first opening, a main portion extending from the left side wall, and a trapdoor attached to the main portion, the trapdoor having a second opening therein and having a second bearing placed in the second opening, the transmission case defining an area for gear placement. The end cover is attached to the trapdoor and extends away from the transmission case to form a cavity therebetween. The end cover has a third opening therein and a third bearing placed in the third opening. The mainshaft gear shaft is supported by the first, second, and third bearings, and the cavity is located between the second and third bearings.

In another exemplary embodiment, the motorcycle transmission includes means for lubricating the third bearing. In yet another exemplary embodiment, a plurality of mainshaft gears are mounted on the mainshaft gear shaft. In still yet another exemplary embodiment, the motorcycle transmission includes a countershaft gear shaft and a plurality of countershaft gears mounted on the countershaft gear shaft. In still yet another exemplary embodiment, each mainshaft gear meshes with a corresponding countershaft gear to form a plurality of gear couplings, and one of the gears from each gear coupling is rotatably coupled to its corresponding gear shaft and the remaining gear from each gear coupling is non-rotatably coupled to its corresponding gear shaft.

In another exemplary embodiment, the motorcycle transmission includes an output gear extending from the transmission case into the cavity. In yet another exemplary embodiment, the motorcycle transmission includes a pulley bearing coupled to the output gear and a pulley coupled to the pulley bearing.

In another exemplary embodiment, the motorcycle transmission includes a lubricant path extending from the inside area of the transmission case to the third bearing. In yet another exemplary embodiment, the motorcycle transmission includes a gear configured to pump lubricant along the lubricant path to the third bearing.

In one exemplary embodiment of the invention, a motorcycle transmission includes a transmission case having an inside area with a groove located therein, a gear having gear teeth configured to move within the groove, an end cover coupled to the transmission case and a lubricant path extending from the groove through the transmission case and the end cover.

In another exemplary embodiment, the groove is defined by a trough, and the trough is coupled to the transmission case within the inside area of the transmission case.

In another exemplary embodiment, the motorcycle transmission includes a bearing housed in the end cover. The bearing has a channel. In yet another exemplary embodiment, the channel forms a portion of the lubricant path. In still yet another exemplary embodiment, the lubricant path extends in sequence from the inside area of the transmission case, within a wall of the trough, within a wall of the transmission case, within a wall of the end cover, through the channel located in the bearing, within the wall of the end cover, and within the wall of the transmission case, whereupon it connects with the inside area of the transmission case.

In another exemplary embodiment, the motorcycle transmission includes a lubricant located in the inside area of the transmission case and along the lubricant path, wherein the lubricant travels along the lubricant path. In yet another exemplary embodiment, the gear includes gear teeth configured to pass over a portion of the lubricant path located within the wall of the trough. In still yet another exemplary embodiment, the gear pumps the lubricant through the lubricant path.

In another exemplary embodiment, the motorcycle transmission includes a mainshaft gear shaft extending from a left side of the transmission case and from a right side of the transmission case, and an output gear mounted on the mainshaft gear shaft. A portion of the output gear extends from the right side of the transmission case, and the mainshaft gear shaft is supported by the bearing at a right end of the mainshaft gear shaft. In yet another exemplary embodiment, the motorcycle transmission includes a pulley bearing coupled to the output gear. In still yet another exemplary embodiment, the motorcycle transmission includes a pulley coupled to the pulley bearing.

In one exemplary embodiment of the invention, the motorcycle transmission includes a transmission case having a first opening and a second opening, a first bearing placed within the first opening, a second bearing placed within the second opening, a mainshaft gear shaft disposed within the first opening and the second opening, and a bearing adaptor disposed between the mainshaft gear shaft and the first circular bearing. The mainshaft gear shaft extends through the first bearing and is supported by the second bearing. The bearing adaptor has an inner surface which contacts the mainshaft gear shaft and an outer surface that is tiered. The bearing adaptor is non-rotatably coupled to the mainshaft gear shaft.

The invention provides a motorcycle. In one exemplary embodiment of the invention, the motorcycle has, when viewed from above, a right side and a left side, and includes a transmission case which includes a left side wall located on the left side of the motorcycle and having a first opening and having a first bearing placed in the first opening, a main portion extending from the left side wall toward the right side of the motorcycle, and a trapdoor attached to the main portion and having a second opening and having a second bearing placed in the second opening. The transmission case defines an area for gear placement. The motorcycle also includes an end cover attached to the trapdoor and extending away from the transmission case to form a cavity therebetween. The end cover has a third opening and a third bearing placed in the third opening and is located on the right side of the motorcycle. The motorcycle also includes a mainshaft gear shaft supported by the first, second, and third bearings. The cavity is located between the second and third bearings, and the mainshaft gear shaft receives an input on the left side of the motorcycle. The motorcycle also includes an output gear mounted on the mainshaft gear and located on the right side of the motorcycle.

### BRIEF DESCRIPTION OF THE DRAWINGS

FIG. 1 is a cross-sectional view of a prior art right side drive motorcycle transmission;

FIG. 2 is a cross-sectional view of a right side drive motorcycle transmission according to an exemplary embodiment of the present invention;

FIG. 3 is an expanded component view of the components of an exemplary embodiment of the present invention;

FIG. 4A is a right side view of a countershaft 5th gear and a trough according to an exemplary embodiment of the present invention;

FIG. 4B is a cross-sectional view of the countershaft 5th gear and trough of FIG. 4A;

FIG. 4C shows a cross-sectional view of the countershaft 5th gear and a mainshaft 5th gear inside the transmission case and from the left side of the transmission;

FIG. 4D shows a perspective view of the trough with the countershaft 5th gear removed;

FIG. 5A is a right side view of a motorcycle transmission according to the present invention; and

FIG. 5B is a cross sectional view of a portion of the motorcycle transmission taken along the line 5B-5B of FIG. 5A.

### DETAILED DESCRIPTION OF THE INVENTION

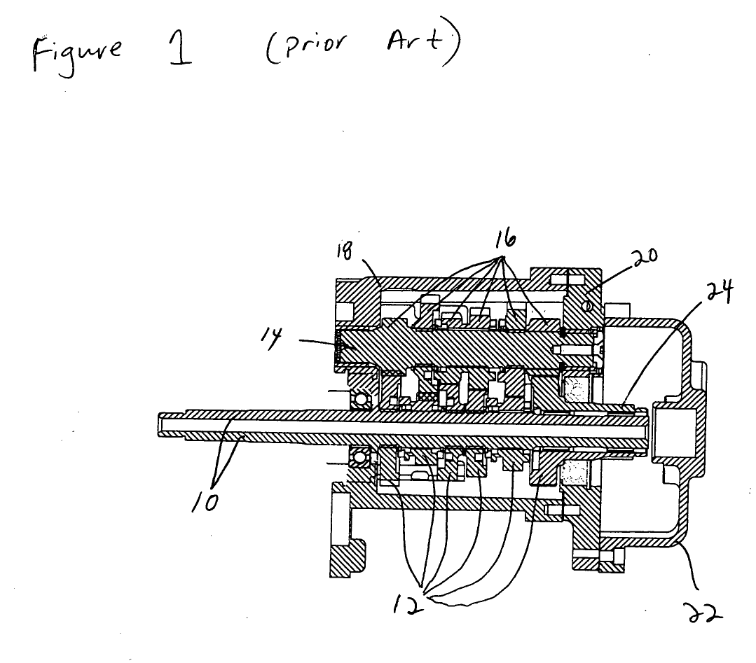

A prior art cross-sectional representation of a right side drive motorcycle transmission is shown in FIG. 1 and includes a mainshaft 10 with a plurality of mainshaft gears 12 mounted thereon, a countershaft 14 with a plurality of countershaft gears 16 mounted thereon, a transmission case 18, a trap door 20, and an end cover 22. An output gear 24 protrudes from the trap door 22 and drives a pulley (not shown) which in turn drives the back wheel of the motorcycle. As can be seen in the cross section of FIG. 1, no bearing support exists between the end cover 22 and the main shaft 10.

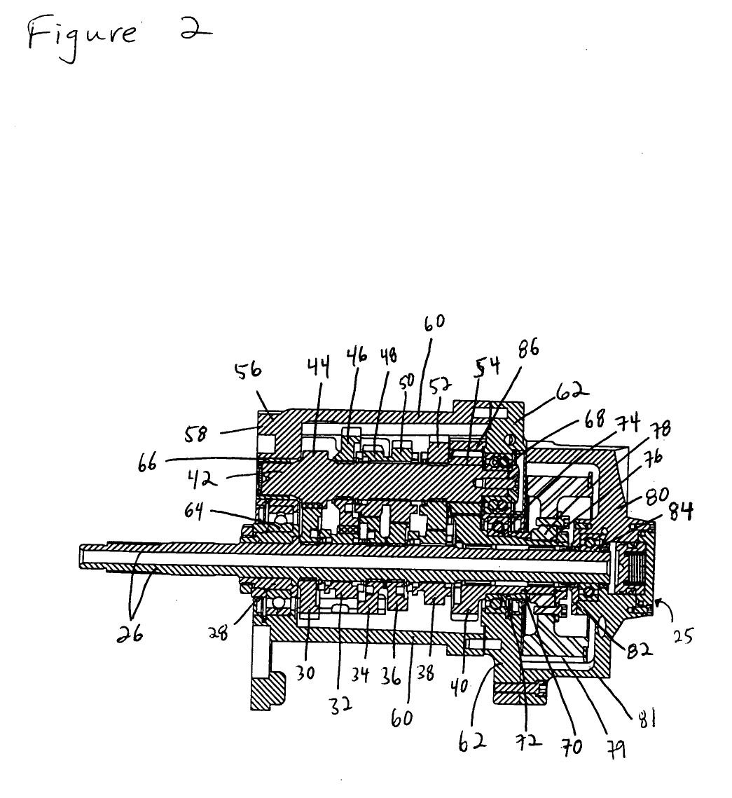

With reference to FIGS. 2 and 3, a right side transmission 25 to be used in motorcycle includes a mainshaft 26 having mounted thereto, a bearing adaptor 28, a mainshaft 6th gear 30, a mainshaft 1st gear 32, a mainshaft 4th gear 34, a mainshaft 3rd gear 36, a mainshaft 2nd gear 38, and mainshaft 5th gear 40.

The transmission 25 further includes a countershaft 42 having a countershaft 6th gear 44 integrated thereon and having mounted thereto, a countershaft 1st gear 46, a countershaft 3rd gear 48 and a countershaft 4th gear 50 being formed of one part, a countershaft 2nd gear 52, and a countershaft 5th gear 54. Each mainshaft gear meshes with a corresponding countershaft gear to form a plurality of gear couplings. One of the gears from each gear coupling is rotatably coupled its corresponding gear shaft and the remaining gear from each gear coupling is non-rotatably coupled to its corresponding gear shaft. The gears of the exemplary embodiment shown in FIGS. 2 and 3 work according to methods known in the art. The exemplary embodiment includes an input from a motorcycle engine on a left side of the motorcycle (when the motorcycle is viewed from the perspective of a motorcycle rider, above the motorcycle) at the mainshaft 26. A mainshaft gear, as for example the mainshaft 5th gear 40, acts as an output gear and is located on a right side of the motorcycle (when the motorcycle is viewed from the perspective of a motorcycle rider, above the motorcycle) to drive a back wheel of the motorcycle.

The gear assembly is housed in a transmission case 56 which includes a left side 58, a main portion 60, and a trapdoor 62 secured to the main portion 60 along the right side of the motorcycle transmission 25. The left side 58 of the transmission case is located on the left side of the motorcycle. The bearing adaptor 28 located along the mainshaft 26 is supported by a first circular bearing 64 which is placed in a first circular opening in the left side 58 of the transmission case 56. The bearing adaptor 28 is non-rotatably connected to the mainshaft 26. The shape of the adaptor bearing 28 allows for a larger circular bearing 64 to be used than is normally used in the prior art. A larger circular bearing provides more robust support to the mainshaft 26 than is provided by the prior art. Further, the multi-tiered design of the bearing adaptor 28 includes shoulder surfaces 28A and 28B, which bear against other components of the transmission to prevent undesirable horizontal translation of the mainshaft 26.

The countershaft 42 is supported by a second circular bearing 66 which is placed in a second circular opening in the left side 58 of the transmission case 56. The countershaft 42 is supported by a third circular bearing 68 which is placed in a first circular opening of the trap door 62.

A portion 70 of the mainshaft 5th gear 40 protrudes from the transmission case 56 along the mainshaft 26. A surface 72 of the protruding portion 70 of the mainshaft 5th gear 40 contacts a fourth circular bearing 74 which is located in a second circular opening in the trapdoor 62. The protruding portion 70 also includes a splined area 76, to which a pulley bearing 78 is coupled. The pulley bearing 78 includes an outer surface 79 to which a pulley or drive belt (not shown). The pulley is located on the right side of the motorcycle and extends to drive the back wheel of the motorcycle.

The mainshaft 26 and pulley bearing 78 are housed in an end cover 80 (not shown in FIG. 3) defining a cavity 81 with the end cover 80 secured to the trap door 62, on the right side of the motorcycle. The end cover 80 includes openings (not shown) through which the pulley or drive belt can pass to drive the back wheel of the motorcycle. An inner surface 82 of the end cover 80 includes a circular plug opening wherein a fifth circular bearing 84 is placed. The mainshaft 26 is supported by the fifth circular bearing 84, which provides bearing support for the mainshaft 26 at its far right end. Other components of the transmission shown in FIGS. 2 and 3 which are not referenced are known in the art.

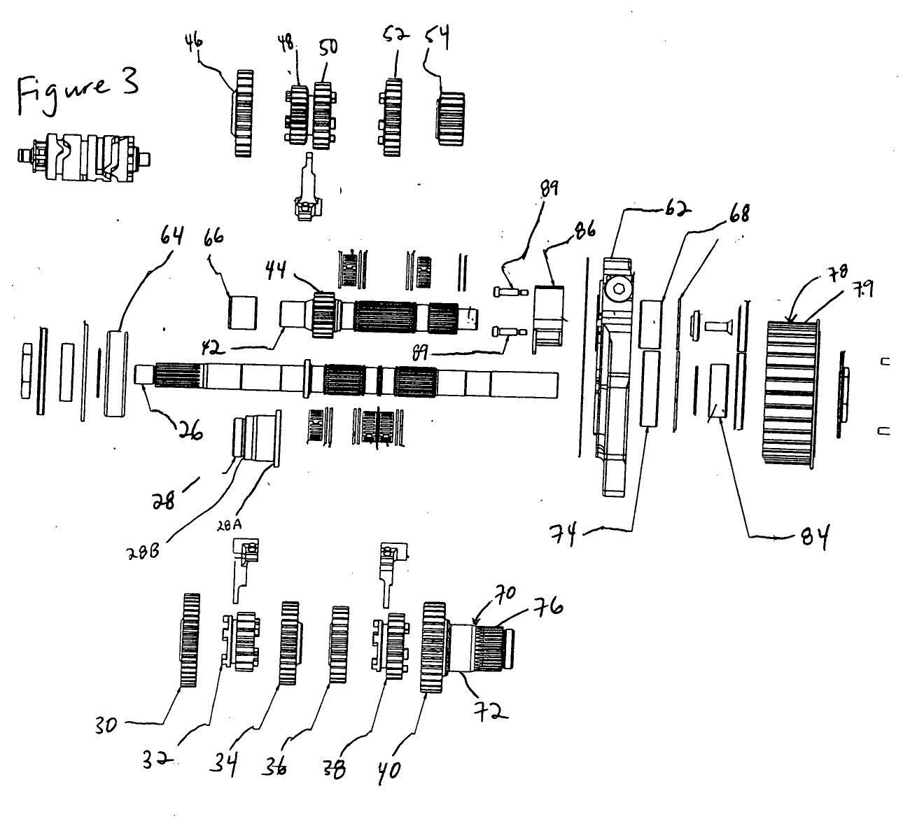

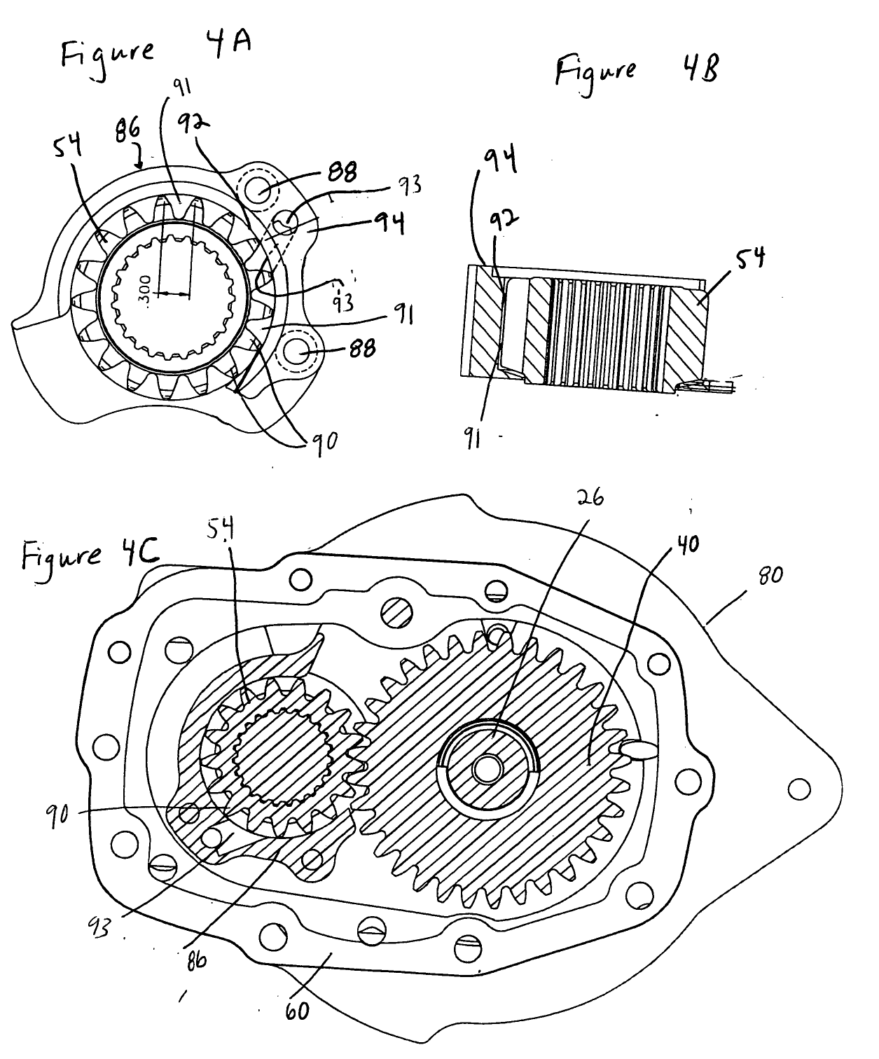

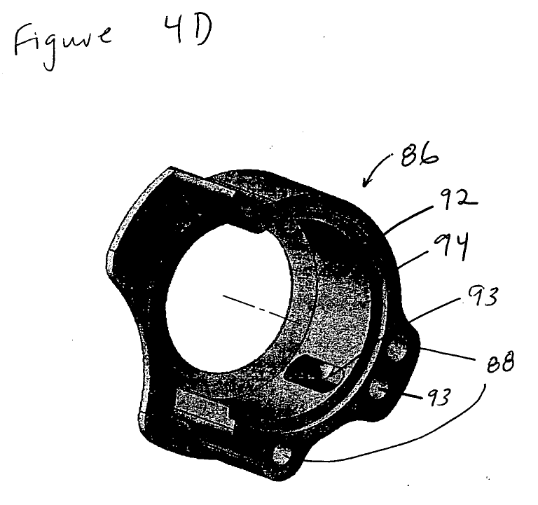

With reference to FIGS. 4A, 4B, 4C, and 4D, the countershaft 5th gear 54 is placed within a trough 86. The trough 86 is a generally annularly shaped member and partially covers the countershaft 5th gear 54, leaving a portion of the countershaft 5th gear 54 exposed to the inside of the transmission case 56, and allowing the gear coupling formed by the countershaft 5th gear 54 and the mainshaft 5th gear 40 to be formed thereabout. The trough 86 is secured to the trapdoor 62. In an exemplary embodiment as shown in FIG. 3, fasteners 89 penetrate fastener openings 88, securing the trough 86 to the trapdoor 62. Gear teeth 90 are placed in a groove 91 bounded mostly by an interior surface 92 of the trough. When the transmission is in operation, the countershaft 5th gear 54 rotates and the gear teeth 90 move through the groove 91. The interior surface 92 extends partially around the circumference of the countershaft 5th gear 54 and fully along the length of the gear teeth 90, as seen in FIG. 4B. An opening 93 passes from the interior surface 92 to an exterior surface 94 of the trough 86 through a wall of the trough 86. The exterior surface 94 is placed against the trapdoor 62 when the trough 86 is secured thereto by the fasteners 89 (see FIG. 3).

During transmission operation, the mainshaft 5th gear 40, by virtue of forming the output gear of the transmission, rotates about the mainshaft 26. The countershaft 5th gear 54 also rotates by virtue of its meshing with the mainshaft 5th gear 40, delivering lubricant to the fifth circular bearing located in the end cover 80 (see FIG. 2), as described below.

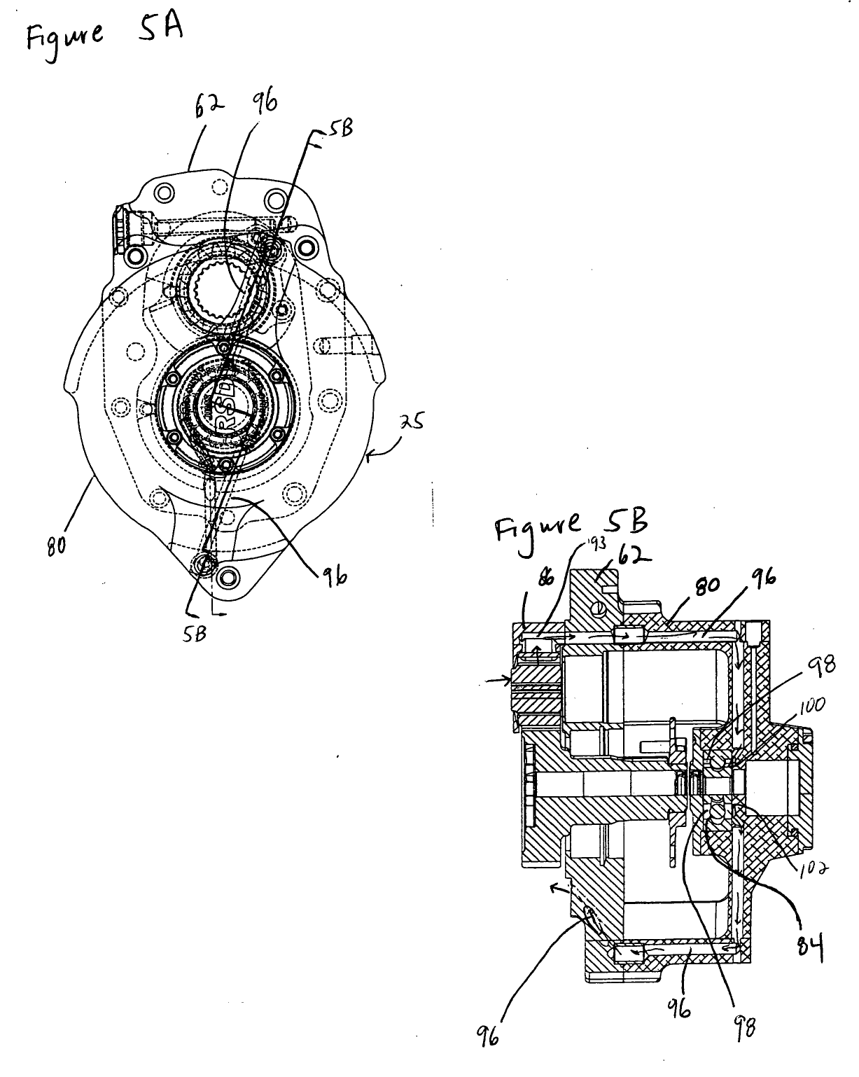

With reference to FIGS. 5A and 5B, the opening 93 of the trough 86 is aligned with and becomes a part of a lubricant path 96 that extends through a wall of the trough 86, through a wall of the trapdoor 62, and through a wall of the end cover 80 to the fifth circular bearing 84. Lubricant enters the space between the gear teeth 90 of the countershaft 5th gear 54 (see FIG. 4A) and travels the lubricant path 96 according to the arrows of FIG. 5B, passing through the fifth circular bearing 84 to provide needed lubrication and cooling to the fifth circular bearing 84. A channel 98 located within the fifth circular bearing 84 receives the lubricant traveling the lubricant path 96. The channel 98 extends circularly within the fifth circular bearing and is placed in communication with the lubricant path 96 at first and second sites 100, 102 located at the interface between the end cover 80 and the fifth circular bearing 84. Lubricant flows into the channel 98 at the first site 100, and flows out of the channel at the second site 102. The lubricant path 96 also extends from the second site 102 through the wall of the end cover 80 and the wall of the trapdoor 62. Although not entirely shown in FIG. 5B, the lubricant path extends from the end cover 80, through the trap door 62, and into the inside area of the transmission case 56 (see FIG. 2) to complete the lubricant path as herein described. Lubricant travels from the fifth circular bearing 84, through the lubricant path 96, and returns to the inside of the transmission case 56 (see FIG. 2) as shown by the arrows.

The lubricant in the inside area of the transmission case in general may be pressurized in order to better ensure that the pumping action results in lubricant travel through the lubricant path 96. With reference to FIGS. 4A and 5B, the gear teeth 90 of the countershaft 5th gear 54 (see FIG. 4A) act as a pump to move the lubricant from the groove 91 into the opening 93 of the trough 86 and through the lubricant path 96. The groove 91 is also bounded by the trapdoor 62. As lubricant is carried by the gear teeth 90 into the groove 91, it is pressurized at a level above that of the lubricant in the transmission case. The additional pressurization of the lubricant occurs due to the confinement of the lubricant in the area defined between gear teeth 90 and the groove 91. As the lubricant is carried in the circular path of the groove 91, it achieves a velocity in a circular direction. A measure of the lubricant escapes the pressurization of the groove by passing into the opening 93. The opening 93 can also be angled to correspond to the direction of velocity of the lubricant, allowing the lubricant to more easily enter the opening 93 from the groove 91. The pumping action of the countershaft 5th gear 54 causes the lubricant to travel through the lubricant path 96.

The heat generated by the fifth circular bearing 84 during transmission operation is at least partially absorbed and carried away by the lubricant as it passes through the fifth circular bearing 84. The presence of lubricant at the fifth circular bearing 84 also facilitates the rotation of the mainshaft 26, and allows the fifth circular bearing 84 to provide the needed support to the mainshaft 26 at its far right end (see FIG. 2). The mainshaft 26 is better suited to support the mainshaft 5th gear 40 and pulley bearing 78 because it is supported on opposing sides of the pulley bearing 78, at the trapdoor 62 and the end cover 80 (see FIG. 2).

The present invention has been described by way of exemplary embodiments. Specific descriptions are not intended as limitations of the invention. The current invention also covers other embodiments within the scope of the invention but not specifically described herein. For example, if a coupling of two components is described as being accomplished by a fastener, it is understood that the two components could be made integral as well, or may be attached using other known methods. It is also understood that the current invention can be used to retrofit to an existing right side transmission.

What is claimed is:

1. A motorcycle transmission comprising:
a transmission case comprising:
a left side wall having a first opening therein and having a first bearing placed in the first opening,
a main portion extending from the left side wall, and
a trapdoor attached to the main portion, the trapdoor having a second opening therein and having a second bearing placed in the second opening, the transmission case defining an area for gear placement;
an end cover attached to the trapdoor and extending away from the transmission case to form a cavity therebetween, the end cover having a third opening therein and having a third bearing placed in the third opening; and
a mainshaft gear shaft supported by the first, second, and third bearings, wherein the cavity is located between the second and third bearings.

2. The motorcycle transmission according to claim 1, further comprising means for lubricating the third bearing.

3. The motorcycle transmission according to claim 2, further comprising a plurality of mainshaft gears mounted on the mainshaft gear shaft.

4. The motorcycle transmission according to claim 3, further comprising a countershaft gear shaft and a plurality of countershaft gears mounted on the countershaft gear shaft.

5. The motorcycle transmission according to claim 4, wherein each mainshaft gear meshes with a corresponding countershaft gear to form a plurality of gear couplings, and wherein one of the gears from each gear coupling is rotatably coupled to its corresponding gear shaft and the remaining gear from each gear coupling is non-rotatably coupled to its corresponding gear shaft.

6. The motorcycle transmission according to claim 1, further comprising an output gear extending from the transmission case into the cavity.

7. The motorcycle transmission according to claim 6, further comprising a pulley bearing coupled to the output gear and a pulley coupled to the pulley bearing.

8. The motorcycle transmission according to claim 1, further comprising a lubricant path extending from the inside area of the transmission case to the third bearing.

9. The motorcycle transmission according to claim 1, further comprising a gear configured to pump lubricant along the lubricant path to the third bearing.

10. A motorcycle transmission comprising:
a transmission case having an inside area with a groove located therein;
a gear having gear teeth configured to move within the groove;
an end cover coupled to the transmission case; and
a lubricant path extending from the groove through the transmission case and the end cover.

11. The motorcycle transmission according to claim 10, wherein the groove is defined by a trough, the trough being coupled to the transmission case within the inside area of the transmission case.

12. The motorcycle transmission according to claim 11 and further comprising a bearing housed in the end cover, the bearing having a channel.

13. The motorcycle transmission according to claim 12, wherein the channel forms a portion of the lubricant path.

14. The motorcycle transmission according to claim 12, wherein the lubricant path extends in sequence from the inside area of the transmission case, within a wall of the trough, within a wall of the transmission case, within a wall of the end cover, through the channel located in the bearing, within the wall of the end cover, and within the wall of the transmission case, whereupon it connects with the inside area of the transmission case.

15. The motorcycle transmission according to claim 14 and further comprising a lubricant located in the inside area of the transmission case and along the lubricant path, wherein the lubricant travels along the lubricant path.

16. The motorcycle transmission according to claim 15, wherein the gear includes gear teeth configured to pass over a portion of the lubricant path located within the wall of the trough.

17. The motorcycle transmission according to claim 16, wherein the gear pumps the lubricant through the lubricant path.

18. The motorcycle transmission according to claim 12 and further comprising a mainshaft gear shaft extending from a left side of the transmission case and from a right side of the transmission case, and an output gear mounted on the mainshaft gear shaft, a portion of the output gear extending from the right side of the transmission case, wherein the mainshaft gear shaft is supported by the bearing at a right end of the mainshaft gear shaft.

19. The motorcycle transmission according to claim 18 and further comprising a pulley bearing coupled to the output gear.

20. The motorcycle transmission according to claim 19 and further comprising a pulley coupled to the pulley bearing.

21. A motorcycle transmission comprising:
a transmission case having a first opening and a second opening,
a first bearing placed within the first opening,
a second bearing placed within the second opening,
a mainshaft gear shaft disposed within the first opening and the second opening, wherein the mainshaft gear shaft extends through the first bearing and is supported by the second bearing, and
a bearing adaptor disposed between the mainshaft gear shaft and the first circular bearing, the bearing adaptor having an inner surface which contacts the mainshaft gear shaft and an outer surface being tiered, the bearing adaptor being non-rotatably coupled to the mainshaft gear shaft.

22. A motorcycle having, when viewed from above by a motorcycle operator, a right side and a left side, and comprising:
a transmission case comprising:
a left side wall having a first opening therein and having a first bearing placed in the first opening, the left side wall being located on the left side of the motorcycle,
a main portion extending from the left side wall toward the right side of the motorcycle, and
a trapdoor attached to the main portion, the trapdoor having a second opening therein and having a second bearing placed in the second opening, the transmission case defining an area for gear placement;
an end cover attached to the trapdoor and extending away from the transmission case to form a cavity therebetween, the end cover having a third opening therein and having a third bearing placed in the third opening, the end cover being located on the right side of the motorcycle;
a mainshaft gear shaft supported by the first, second, and third bearings, wherein the cavity is located between the second and third bearings, and wherein the mainshaft gear shaft receives an input on the left side of the motorcycle; and
an output gear mounted on the mainshaft gear and located on the right side of the motorcycle.
